(19) United States
(12) Patent Application Publication
(10) Pub. No.: US 2025/0316157 A1
(43) Pub. Date: Oct. 9, 2025

(54) COLLABORATIVE EVENT MANAGEMENT AND RESPONSE FACILITATION

(71) Applicant: Observables, Inc., Santa Barbara, CA (US)

(72) Inventors: Ronald R. Gans, Santa Barbara, CA (US); Abraham M. Schryer, Santa Ynez, CA (US)

(21) Appl. No.: 19/173,621

(22) Filed: Apr. 8, 2025

Related U.S. Application Data
(60) Provisional application No. 63/631,290, filed on Apr. 8, 2024.

(51) Int. Cl. G08B 25/01; G08B 25/10

(52) U.S. Cl. CPC G08B 25/016; G08B 25/10

(57) ABSTRACT

An always on platform reporting incident alerts to key persons and facilitating key persons evaluating and responding to incident alerts is described herein. The platform includes a cloud application on a cloud server and a premises device at a premises. A plurality of sensors are coupled to the premises device via wired and wireless connections. The cloud application receives signals, status and information from the premises device. The cloud application obtains location and pertinent information about key persons. The cloud application evaluates actions to take in response to signals, status and information received from the premises device and additional devices and systems. The cloud application communicates an incident alert to key persons and provides real time, live information about the incident to key persons who use the cloud application to communicate with each other to evaluate the incident alert and plan actions in response, including video conference, text chat, and voice communication.

### RELATED APPLICATION INFORMATION

This patent claims priority from the provisional patent application 63/631,290 filed Apr. 8, 2024, which is incorporated by reference herein in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to residential and commercial monitoring, premises devices, automation and security systems and related components that that include a premises device and a cloud server for monitoring and facilitating responding to incident alerts from residential and commercial monitoring, premises devices, automation and security systems and related components.

### Description of the Related Art

Residential and commercial monitoring and security installations include a wide variety of sensors and components. A local controller or premises device may be the hub for the on-location sensors. This may be an alarm panel. Historically, actions were taken in response to the information and signals provided by sensors at the location.

Traditional alarm systems reliably send signals to central stations, where operators follow automated processes to ensure consistent responses to these incidents and minimize liability. Unfortunately, large numbers of these signals are false alarms or user errors generating incidents that do not warrant any emergency service dispatch. These systems leave operators and service providers uncertain about the cause of alarms. This uncertainty leads to inefficiencies, poor service, and unnecessary emergency services dispatches resulting in fines, all of which cause customer frustration. Many cities now require crime confirmation before responding to incident reports, eroding confidence in alarm systems and increasing operator stress.

False alarm reduction is a major industry priority. There has been an increase in the use of video services by central stations but it is very expensive and very intensive on central station labor. Updated alarm systems, video surveillance, internet of things (IoT) devices, artificial intelligence (AI) software and new operation methods are helping reduce false alarms, but the bulk of these issues need to be addressed by the end users directly.

When an incident alert occurs, there is not always a single person who has both the knowledge and availability to evaluate all potential conditions and select an appropriate response. Systems and methods allowing for teams consisting of friends, neighbors, business owners, employees, and contractors, to collaborate to evaluate incidents and determine appropriate responses is needed to dramatically increase certainty of real events and reduce false alarms.

### DESCRIPTION OF THE DRAWINGS

FIG. 1 is a block diagram of an environment in which the systems and methods described herein operate.

FIG. 2 is a block diagram of a virtual configuration of the system described herein.

FIG. 3 is a block diagram of the components of an example premises device that implements a portion of the systems and methods described herein.

FIG. 4 is a flow chart of actions taken according to the systems and methods described herein.

FIG. 5 is a flow chart continuing the actions from FIG. 4 taken according to the systems and methods described herein.

FIG. 6 is a flow chart continuing the actions from FIG. 5 taken according to the systems and methods described herein.

### DETAILED DESCRIPTION

An always-on platform (AOP) system that includes a local system having a programmable premises device and premises software, a mobile-device application, and a server-based Internet web site accessible via the mobile application and a browser providing a Software as a Service (SaaS) interface and cloud application is described herein. The AOP system premises device is located at a home, office or other location running a premises application and a cloud server running a cloud application. The premises device includes a microprocessor, network communications components and related software which receive signals and information from external sensors and components, and communicates with the cloud application. The premises application and cloud application included in the AOP system operate in conjunction with an optional mobile application and website interface to enable a system operator to configure sensors and components coupled with the premises device. The cloud application runs in tandem with the premises application to configure premises sensors and components. The cloud application allows system operator affiliated with the premises to specify local information such as work schedules for personnel and building schedules which are used by the cloud application in evaluating and determining actions to be taken and communication to be sent in response to information and signals received from the premises device. The cloud application allows a system operator affiliated with the premises to specify designated persons aka key personnel to receive incident communications in response to information and signals received from the premises device, external components, and external systems and enable monitoring by the designated persons and facilitate communications among the designated persons via the cloud application and/or the mobile application. The premises system and premises application and server software included in the AOP system combine with the mobile application and website interface to enable users to view and monitor incident alerts and incident information and to facilitate communications among the designated persons aka key personnel.

The cloud application has multiple communications capabilities including land line cellular telephone, email, text message, and internet communications such as WHATSAPP, TEAMS, SIGNAL and FACEBOOK MESSENGER, to send incident alerts to designated persons in response to signals and information received from the premises application originating from the premises sensors and components, external systems, and external components. The cloud application communicates with multiple third parties and prepares responses and communications initiated by designated persons in response to signals and information received from the premises application originating from the premises sensors and components. Moreover, machine learning derived from historical incidents and actions in response to earlier incidents may be incorporated in the cloud application of the AOP system to provide recommended actions to the designated persons.

The AOP system as a whole, including the server SaaS portion aka cloud application and the premises device in combination, facilitate communication and information sharing among multiple designated persons regarding premises systems and devices and security systems and devices. The AOP system is an integrated platform designed to streamline incident management, real-time communication, and coordination across various security and premises systems and devices. By combining data from video surveillance, access control, alarms, premises systems and devices, and IoT sensors, the AOP system enables users to monitor and manage security and premises incidents in real time via the SaaS cloud application. The AOP system may also be used to monitor and respond to personal emergency incidents such as those initiated by Personal Emergency Response Systems (PERS) devices and systems.

### The System

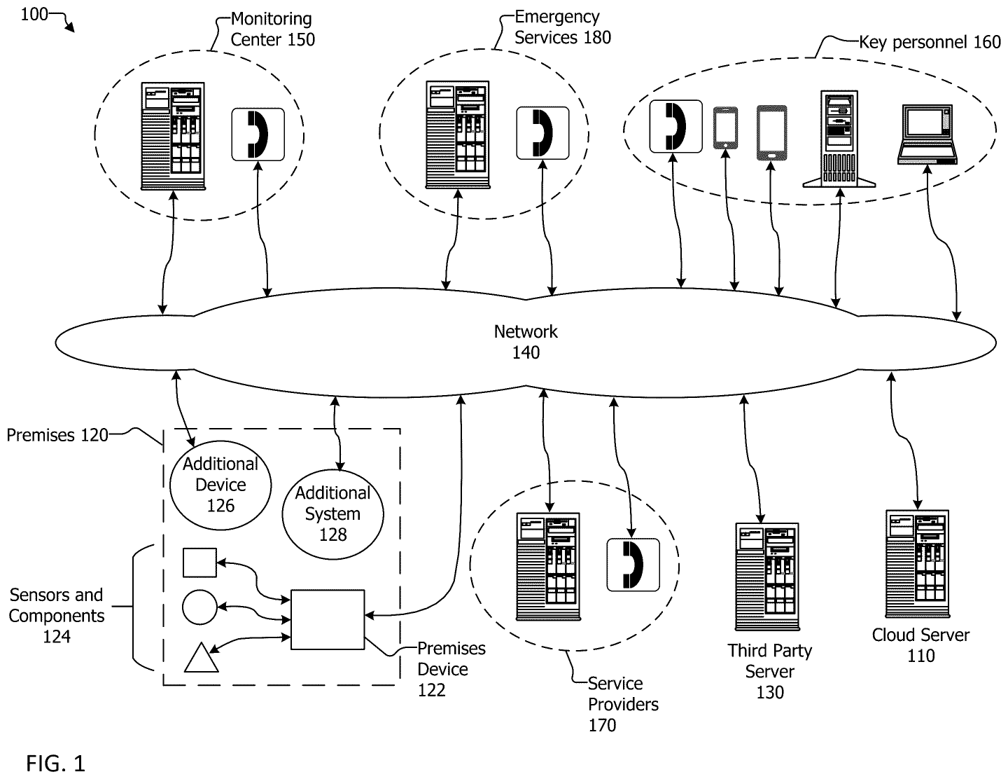

Referring now to FIG. 1, there is shown a block diagram of an environment 100 in which the AOP system described herein operates. The AOP system includes a cloud server 140 running a cloud application that provides a website and mobile application support to users, namely designated persons aka key personnel, on computing devices over network 140. One or more administrative users of the AOP system, namely a system operator affiliated with a premises 120 uses the mobile application or cloud application to control, manage and configure sensors and components 124 external to a premises device 122 at the premises 120 by accessing the website provided by the cloud application at cloud server 110 via computing devices using a web interface provided by cloud application at the cloud server 110 or a mobile application provided as part of the AOP system. The cloud server 110 takes high level commands, configuration and other information provided by system operators via their computing devices over network 140 and sends it to the premises device 122.

The cloud server 110 receives information provided by system operators about designated persons aka key personnel 160 via their computing devices over network 140. The cloud server 110 may send information about key personnel to the premises device 122. Key personnel include owners, managers, leaders and employees of a company or members of a household at a particular premises. Key personnel may include service providers such as plumbers, landscapers, electricians, HVAC contractors, and the like. Key personnel may include family members, healthcare workers, social workers when an incident is a personal medical emergency communicated from a PERS device to the AOP system. The information provided by system operators via their computing devices to the cloud application at cloud server 110 includes building access/open hours, office hours, contact information for third party contractors and service providers, and contact information for owners, managers, leaders and employees of a company or members of a household at the particular location. In some versions of the AOP system the current location of owners, managers, leaders and employees of a company or members of a household may regularly be reported to and received by the cloud application at the cloud server 110.

The premises device 122 directly communicates with the external sensors and components 124, and a premises application on the premises device 122 sends signals, status information, external device data and other information to the cloud application on the cloud server 110. The premises device 122 may also include onboard sensors and report signals and information from onboard sensors to the cloud application on the cloud server 110. In some configurations, additional systems 128 and devices 126 at or adjacent to the premises 120 may register with the cloud application at the cloud server and communicate data and information about the functionality, features, and information about the systems and devices and the premises to the cloud server 110 over network 140. The additional devices and systems may be watering systems, fire and smoke alerts systems, chemical sensing devices, and others. In some configurations, additional systems 128 and devices 126 at or adjacent to the premises 120 may be or include PERS devices and systems that register with the cloud application at the cloud server and communicate personal emergency information and/or communications to the cloud server 110 over network 140.

The cloud application of the AOP system running on the cloud server 110 provides incident information including alerts, sensor data and other information directly and/or via a web interface or app interface over network 140 to key personnel 160 at their computing devices. Key personnel 160 include one or more system operators. In one embodiment, the cloud application of the AOP system running on the cloud server 110 provides alerts, sensor data, updated contact or call lists and/or updated action lists and other information directly over network 140 and/or via a web interface or app interface over network 140 to monitoring center 150.

The cloud application of the AOP system running on the cloud server 110 enables designated persons aka key personnel 160 the ability to view incident information received from the premises device 122 and additional systems 128 and devices 126 over the network 140 via computing devices of the key personnel 160. The cloud application of the AOP system running on the cloud server 110 enables designated persons aka key personnel 160 the ability to communicate with other key personnel to interactively evaluate and discuss incident information received from the premises device 122 and additional systems 128 and devices 126. The cloud application of the AOP system running on the cloud server 110 enables designated persons aka key personnel 160 the ability to communicate with other key personnel to interactively evaluate and discuss incident information such as personal emergency communications received from PERS devices and systems that are shown as additional systems 128 and devices 126, and may also facilitate communications by designated persons with a person who is wearing or accessing a PERS device. The cloud application of the AOP system running on the cloud server 110 enables designated persons aka key personnel 160 the ability to communicate with a security system monitoring center 150; service providers 170 such as electricians, plumbers, HVAC contractors, utility service providers namely representative of water, gas and electric utilities; and emergency services 180 such as police and fire over network 140 using the computing device available to the key personnel.

A computing device as used herein refers to any device with a processor, memory and a storage device that executes instructions including, but not limited to, personal computers, server computers, computing tablets, smart phones, portable computers, and laptop computers. These computing devices may run an operating system, including, for example, variations of the Linux, Android, Microsoft Windows, Apple iOS and Apple Mac operating systems.

The cloud server 110, premises device 122, third party servers 130, emergency services 180, service providers 170, key personnel 160 and monitoring center 150 communicate through a network 140. The network 140 comprises one or more public and/or private data networks, and other networks and sub-networks, and may include or be the Internet. The network 140 may also include or access cellular telephone and land line telephone networks, may include satellite links and microwave transmission links, and may be wired and wireless or a combination. In addition, Global Positioning System (GPS) information providing location information may be accessed directly outside of the network 140 by cloud server 110, premises device 122, sensors and components 124, additional devices 126 and systems 128, and computing devices of key personnel 160. The network 140 includes additional devices, not shown, such as routers, switches, firewalls, multiplexors and other networking equipment that enable and enhance network communications and network security. Additional specialized servers such as application servers, database servers, and others may be coupled with or included in the AOP system 100 and/or may be accessed by the cloud server 110 over network 140. Although only one cloud server 110 and one premises device 122 are shown, multiple cloud servers 110 and premises devices 122 may be involved in the AOP system. Multiple premises devices 122 may be at multiple locations and/or at a single location. That is, multiple premises 120 may be connected to and be part of the functioning and features of the AOP system. Although only one premises 120 is shown, multiple premises may be included in the AOP system.

Monitoring center 150 may be coupled with the network 140 so that signals and status information from sensors and components 124, premises device 122, and/or additional devices 126 and additional systems 128 at premises 120 may be communicated to the monitoring center 150 directly and/or via the cloud application on the cloud server 110.

The methods described herein may be implemented on one or more server computers referred to herein as cloud server 110 running the cloud application of the AOP system, one or more premises devices 122 at one or more premises 120 running premises application software, multiple computing devices of key personnel 160 associated with multiple premises 120, and multiple monitoring centers 150 and the computing devices therein.

The designated persons aka key personnel 160 use computing devices to access the cloud server 110 via a AOP system mobile application running on mobile computing devices or a web interface provided by the cloud application running on cloud server 110 via web browsers included on the computing devices of key personnel 160, and also receive communications (for example, text messages, email, voice calls, automated audio calls) originating from the cloud application on the cloud server 110.

A server computer includes software and hardware for providing the functionality and features described herein. A server computer may include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). Certain portions of the methods, functionality and features described herein are embodied in software which operates on a server computer and may be in the form of firmware, an application program, an applet (e.g., a Java applet), a browser plug-in, a COM object, a dynamic linked library (DLL), a script, one or more subroutines, or an operating system component or service. Server computers include the cloud server 110 as well as servers at the monitoring center 150, service providers 170, emergency services 180, and the third party servers 130.

The cloud application of the AOP system may be implemented in software and stored on a machine readable storage medium in a storage device included with or otherwise coupled or attached to the cloud server 110. That is, the cloud application of the AOP system software is stored on machine readable storage media. These storage media include various kinds of physical media, namely: magnetic media such as hard disk drives (HDDs); optical media such as compact disks (CD-ROM and CD-RW) and digital versatile disks (DVD and DVD+RW); silicon media such as solid-state drives (SSDs) and flash memory cards; and other magnetic, optical or silicon storage media. As used herein, a storage device is a device that allows for reading and/or writing to a storage medium. Storage devices include hard disk drives, DVD drives, SSDs, EEPROMs, flash memory devices, and other magnetic, silicon, optical or other physical media.

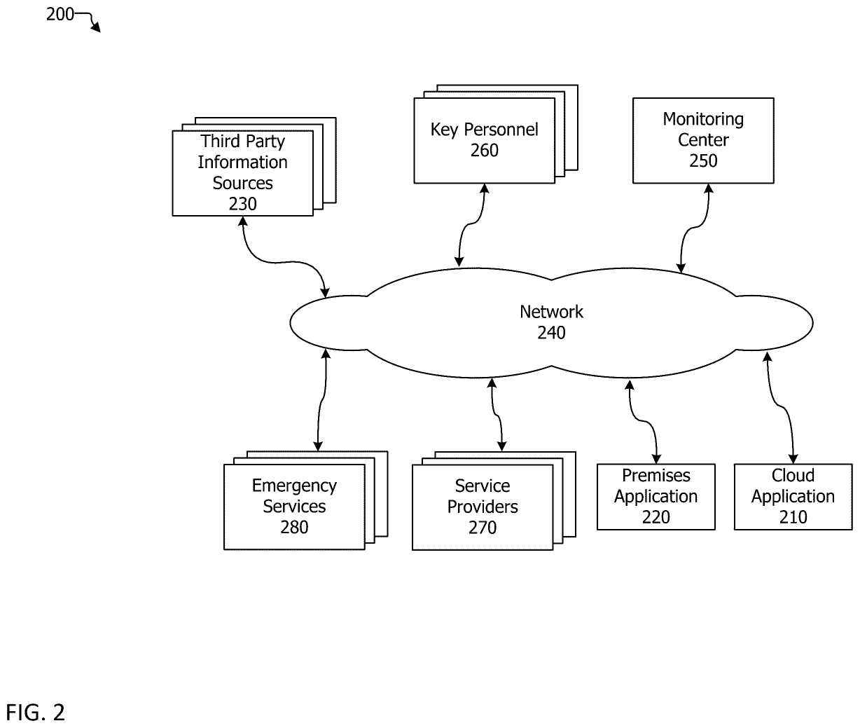

Referring now to FIG. 2, there is shown a block diagram of a virtual configuration 200 of the AOP system described herein. This discussion also includes reference to FIG. 1. The AOP system includes cloud application 210 on a cloud server 140 that includes website and mobile application support software. The AOP system may include a mobile application running on mobile computing devices of key personnel 260. A system operator and/or other administrator via their computing devices provide configuration, control commands and other information over network 240 to the cloud application 210 via a website and/or app support software of the cloud application 210 running on the cloud server 110. The cloud application 210 includes premises device support software that communicates with premises application 220 running on premises device 122 at premises 120 over networks 140 and 240. The cloud application 210 enables a system operator and/or other administrators to communicate control, configuration and command information to the sensors and components 124 and premises device 122 via premises application 220 that runs on premises device 122 as well as to additional devises 126 and additional systems 128 included at or adjacent to premises 120. The cloud application 210 receives incident information including data and signals from the sensors and components 124 and premises device 122 from premises application 220 that runs on premises device 122 as well as from additional devises 126 and additional systems 128 included at, in or adjacent to premises 120.

The premises application 220 on premises device 120 takes inventory of connected external sensors, devices and components. The sensors, devices and components 122 include alarm panels, key pads, access readers, phones, intercoms, door controllers, roof sensors, gunshot detectors, keycard readers, badge readers, man-traps, virtual wires, tamper detectors, biometric devices such as ophthalmic and fingerprint readers, temperature sensors, fire alarms, light sensors, motion sensors, water sensors, humidity sensors, window state sensors, audio sensors, earthquake sensors, accelerometers, door sensors, glass break sensors, video cameras or sensors, and others. The sensors, devices and components may be included in a premises in the form of a single structure, be part of a campus or plant, or be spread across one or more buildings on a property site and may include sensors, devices and components inside and outside of buildings. The premises may also be a boat, recreational vehicle or other movable structure or vehicle; may include property and buildings, and structures; may include multiple buildings or structures; and may be or have adjacent to it vehicles.

The cloud application 210 provides an easy to use graphical interface via a web interface and may have an associated mobile application that provides system operators and other administrators the ability to view, monitor, configure and control the external devices, components and systems 122 coupled with the premises device 122 via premises application 220 and additional devices 126 and additional systems 128. The cloud application 210 provides an easy to use graphical interface via a web interface and optional associated mobile application that provides designated persons and/or other key personnel 260 the ability to receive incident information and data from and view and monitor the devices, components and systems 122 coupled with the premises device 122 via premises application 220 as well as additional devices 126 and additional systems 128 associated with or at the premises 120. The premises device 122 and premises application 220 support as external components virtually any sensor that communicates via a voltage, current, resistance, or communication bus message, alert or signal, and related data.

The cloud application 210 provides an easy to use graphical interface via a web interface and optional associated mobile application that provides designated persons and/or other key personnel 260 the ability to communicate with each other about incident information and data from and concurrently view and monitor the devices, components and systems 122 coupled with the premises device 122 via premises application 220 as well as additional devices 126 and additional systems 128 associated with or at the premises 120. The AOP system enables designated persons and/or other key personnel 260 the ability to communicate with each other about the incident information and evaluate as a team an appropriate response to the incident.

The cloud application 210 provides an easy to use graphical interface via a web interface and optional associated mobile application that provides designated persons and/or other key personnel 260 the ability to communicate an incident response decision and initiate incident response communications and actions with a monitoring center 250, emergency services 280, and service providers 270 including sharing pertinent incident information and data from the devices, components and systems 122 coupled with the premises device 122 via premises application 220 as well as from additional devices 126 and additional systems 128 associated with or at the premises 120.

The cloud application 210 allows system operators and administrators, such as owners, managers and company leaders, to specify premises information such as work schedules for personnel and building schedules as well as time clock information (that is, when personnel have checked in or out of a building or office) which are used by the cloud application 210 in evaluating and determining actions to be taken and communication to be sent in response to information and signals received from the premises device 122 via premises application 220. The cloud application 210 allows system operators and administrators to specify service providers 270 such as electricians, plumbers, HVAC contractors, electric service providers, water providers, natural gas providers, propane providers, chemical providers which are used by the cloud application 210 in evaluating and determining recommended actions to be taken to be included in incident communications to be sent to designated persons and key personnel 250 in response to information and signals received from the premises device 122 via premises application 220. In addition, The cloud application 210 allows system operators and administrators to specify service providers 270 such as health care professionals, social workers, and the like which are used by the cloud application 210 in evaluating and determining recommended actions to be taken to be included in incident communications to be sent to designated persons and key personnel 250 in response to information and alerts received from PERS devices and systems registered with the cloud application 210.

The designated persons and key personnel 250 evaluate the incident information and cloud application recommendations for contacting a monitoring center 250, service providers 270, emergency service 280. Should key personnel not respond to the notification of the event, based on timers, the cloud application may optionally automatically escalate the event to additional or other key personnel or a central monitoring station.

In addition, the cloud application 210 may communicate with multiple third party information resources 230 to obtain information pertinent to the decisions to be made and actions to be taken in response to local signals and information, such as weather reports, weather incidents, sunrise and sunset times, fire incidents, flood information, police activity, and the like. Third party information about the status of utilities such as water, electricity and gas as well as Internet connectivity is also obtained by the cloud application 210 from third party information sources 230 to assist in evaluating actions to be taken in response to signals and information from premises device 122 connected sensors and device 122 via the premises application 220. Third party information sources 230 include weather forecasters, police departments, fire departments, local governments, National Weather Service, as well as utilities such as water electric, national gas and Internet providers, and others. Based on third party information and local information, the cloud application 210 prepares recommended responses and communications responsive to incident signals and information received from the premises application 220 originating from the premises sensors and components 124. Moreover, the cloud application 210 incorporates machine learning incorporating user adjustments and changes responsive to earlier issued responses and communications. The machine learning makes conclusions and deductions based on sensed and monitored activities so that false positives and false alerts are reduced or eliminated.

Here is one example of machine learning performed by the cloud application. In this example there is a freezer at a premises with a temperature monitor associated with the freezer. The system monitors the freezer temperature. It is preferred that the freezer temperature stays within a defined range. The cloud application may implement a basic rule that when the freezer leaves a certain temperature range, an alert is sent to a designated freezer repair person. Although this is a good general rule, freezers have regular defrost cycles. Rather than trying to predict what those cycles are and create rules around them, the machine learning in the cloud application learns the defrost cycle based on measurements made. That is the machine learning component deduces or learns that there is a defrost cycle in response to regular monitoring of the freezer. The cloud application can then distinguish between “normal” behavior and abnormal problems such that alerts are only sent during an abnormal temperature and ignore anticipated or regular temperature changes. In this example situation, a failsafe rule can be included such that a temperature change outside the desired range for greater than the period of time of a typical defrost cycle causes an alert or alarm to be triggered for evaluation by designated key personnel.

The cloud application 210 provides key personnel 250 the ability to communicate with one another. The cloud application 210 provides key personnel 250 the ability to initiate communications with and actions with emergency services 280, service providers 270 and monitoring center 260. Monitoring center 260 may be a third party security service center. Historically, the monitoring center receives motion detector, fire sensor, door open or glass break alerts and in response to those, calls key personnel, fire and/or police as the case may be. Here, according to the AOP system, the cloud application 210 may provide the monitoring center 260 with instructions on how to respond to an incident based on an incident response or action specified by key personnel 250 via the cloud application or mobile application. The alarm industry standard is that after an alarm panel goes into alarm mode, there is a 60 second delay before the central station (monitoring center herein) is contacted in an effort to reduce false alarms. The cloud application of the AOP system and optional accompanying mobile application allow key personnel to take action regarding the incident while offsite, reducing the occurrence of false alarms. The cloud application of the AOP system and optional accompanying mobile application can take those 60 seconds back and give them to the local users, namely key personnel at a premises, and using the cloud application and mobile application of the AOP system collaborate regarding the incident and determine if a false alarm or other event that requires action that does not involve emergency services, or verify if an event does require an emergency services response. According to the AOP system's cloud application and optional mobile application, response to an alarm is not delayed but premises owners and operators are empowered to take a more applicable response to an incident alarm.

Here is an example of the functioning of the AOP system's cloud application and optional mobile application. If a water sensor shows too much water is being used, the premises application sends data and information to the cloud application 210 which sends incident information to key personnel 250. The cloud application 210 may include a recommendation to contact a plumber (one of the service providers 270) based on evaluation of the incident information along with the incident information communicated to key personnel. The cloud application, in one embodiment, maintains the geographical location of key personnel 250 so that key personnel geographically closest to the premises are provided the incident information along with a recommendation to contact a plumber. Further, time of day may factor into which communication method is used by the cloud application to communicate with key personnel, such that office phones are not called at night if the office hours are 9:00 a.m. to 5:00 p.m. Many more permutations of rules based on available information are used by the cloud application 210, including machine learning to improve the kinds of communications and recommendations communicated by the cloud application to the key personnel 250.

In one implementation, the cloud application rules engine may include rules based on the following:
Trigger—Specifies what external event launches the rule. Triggers include inputs, such as alarm sensor (door, window, glass break, water, panic button, etc.) message received, signal received, measurement made, property changed, picture or video clip taken, anything from any of the listed data sources/sensors, or based on a certain time interval or time (date, time, day of week, time of day, etc.).
Scope—Specifies how broadly to apply the rule. Scope covers how widely the rule is applied. The rule may apply to a certain sensor, a particular building, an entire campus, an organization, etc.
Conditions—Limit when the rule runs. Conditions are constraints around the rules. Conditions include the type of message, measurements in certain ranges, the day or time of day, weather conditions, no more often than a certain frequency, and others.
Actions—What to do when the rule runs and the application condition or conditions are met. Actions are what happens when the rule's condition or conditions are met. Actions include send email, send SMS, send text to voice, specify escalation path, alert monitoring center, take automatic action on premises, alert police, alert fire, alert key personnel, etc.

In one version of the cloud application, a rule-based state machine is used. In another version of the system, the rule-based state machine is included in the premises application in the premises device. In another version of the system, portions of the rule-based state machine are included in both the cloud application and the premises application. In the state machine, a flow is a set of states, containing rules, governed by inputs, and producing outputs. A flow contains a map of states keyed by the State ID. Each flow contains an ordered list of rules executed from any state. A flow tracks the current state and last state change time and allows for custom storage of key-value pairs for rules. Multiple flows are supported. A state is a position in a flow. Each state contains an ordered list of rules that are executed when in that state. A rule is a condition that depends on input, namely information, signals and data from sensors at and provided from a premises device as well as third party information sources. The evaluation of a rule results in a true, false, or indeterminate evaluation. If a rule evaluates to true, associated outputs are communicated and/or the particular related or associated state is changed. A container rule is a special type of rule that contains one or more other rules and bases its condition on the conditions of the contained rules. Container rules may be nested. An input is any sensor or other component included with or coupled to a premises device that changes independently and whose properties can be measured, typically signals, data, messages or status the local system receives from connected external components and external systems. Example input includes GPIO pin signals, motion detection signals and status, temperature, time, humidity, light on, door open, window open, broken glass, elapsed time since a particular event or occurrence, and others. An output from the cloud application at the cloud server may also be an input to a premises device and/or and external component coupled with, included in or connected to the premises device. An output includes an aspect of the premises device or a component connected or coupled with the premises device that can be set or controlled, typically configuration information and instructions or commands to connected external components and external systems. Other outputs include instructions to send a message to a monitoring center server, send message to a key person, send a pin signal to a particular component or device, send email, send text message, send SIP communication, send local network message, set premises device LED on or off, send command signal to unlock door at premises, send command signal to trigger an audio alarm at premises, send command signal to trigger a visual alarm at premises, and others.

Example rules included with the state machine include: evaluating if pin is high or a signal code received, then entering a particular state; evaluating if a temperature is outside of a predefined or user specified range, then issuing a command to the premises device to turn on a heater and/or sending an alert communication to the monitoring center; evaluating if a time since a last transition is too large or exceed a threshold then taking a pre-defined or user specified action; evaluating if a signal or pin or combination of signals and pins from one or multiple sensors or components coupled with or connected to the premises device is high while another is also high then taking a predefined or user specified action. The predefined actions may be system defined defaults and/or may be specified by a system operator during initial configuration or later configuration and tuning of the cloud application's machine learning and intelligence system. System operator specified actions may be provided via the web interface or mobile application to the cloud application on the cloud server.

Upon initial configuration of the cloud application by a system operator, the cloud application may provide an easy to use configuration user interface that enables a system operator to set triggers, namely boundaries, thresholds and time periods relating to sensors and components coupled with the premises device. Predefined cloud application defaults may be provided for some or all sensors and components, and the cloud application may allow the system operator to customize the values to meet the needs of the particular premises. The rules in the cloud application obtain not only signals and status from the sensors and components on the premises device but also obtain (pull) and receive (push) pertinent information from third party information sources. For example, a rule relating to fire detection may obtain humidity and outside temperature information from a weather information source and compare it to the humidity and temperature from sensors coupled or included with a premises device while also checking whether there is a power outage in the geographical area near the premises and whether the air conditioning system at the premises is functioning to evaluate whether there is a fire in the building. Other rules take into consideration the kind of signal (input) received to determine which key personnel should be contacted (output). For example, prepare a call or contact list to be sent to the monitoring center that includes the closest company leader and particular trade specialist based on the temperature being too high or too low, such as an HVAC contractor. In this rule, an additional consideration of time of day may be evaluated to determine the kind of communication recommended based on an urgency determination, such as, for example, direct immediate phone call for most urgent, email for less urgent, or text message for urgent. Other simple and complex rules such as these examples may come pre-installed in the cloud application, may be customized by system operators using the cloud application, and may be authored by the system operator or cloud application provider for specialized or unique configurations.

### The Premises Device

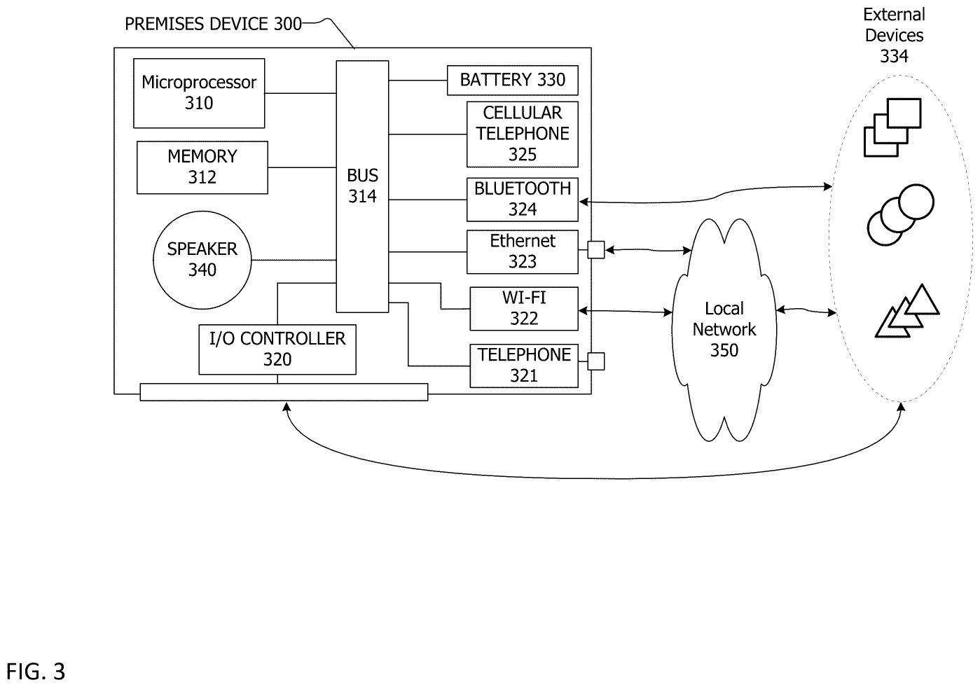

Referring now to FIG. 3, there is shown a block diagram of an example of the components of an example premises device 122 that implements a portion of the systems and methods described herein. The premises device 300 may include or be a single board having multiple components. The premises device 300 may include multiple boards. The premises device 300 includes a microprocessor 310 to execute instructions or software stored on a storage device 312 that implements the premises application 220, including at least one state machine. The storage device 312 may be a ROM, EEPROM, flash memory and the like. The premises device 300 includes electronics and software that allows for communicating with the cloud server 110 and with external sensors and component. The premises device 300 includes electronics and software to allow for one and/or two-way communications with the cloud server 110 and sensors and components 122 devices. The premises device 300 may support some or all of Internet communications, telephone communications, cell phone communications, VOIP communications, BLUETOOTH communications, satellite communications, microwave transmissions, and others.

Specifically, the premises device 300, in various embodiments, includes some or all of a telephone system component 321, a cellular telephone component 325, a WI-FI component 322, an ETHERNET component 323 and a BLUETOOTH component 324. The premises device 300 includes electronics and software in the form of an I/O controller 320 (which may be a general purpose input/output controller or GPIO controller), a WI-FI component 322, an ETHERNET component 323 and a BLUETOOTH component 324 that allow for communicating with external devices 334 (shown as sensors and components 124 in FIG. 1) at the premises or included in a site or plant area, such as fire alarms, smoke detectors, temperature sensors, humidity sensors, glass-break sensors, earthquake sensors, lightning strike sensors, proximity sensors, electric control panels, water monitors, gas monitors, carbon monoxide monitors, electric monitors, light sensors, door sensors, window sensors, motion sensors, security system and monitoring system components, devices and control panels available from multiple manufacturers, as well as video cameras, microphones, audio sensors, humidity sensors, telephone systems, VOIP systems, HVAC systems, digital signage systems, and computer and networking equipment such as firewalls, routers, modems, switches, and other related devices and systems. The external devices 334 may be coupled directly via BLUETOOTH component 324 or wired connection via I/O controller 320 with premises device 300, or may be coupled wired or wirelessly through a computer network such as a LAN (local area network) 350 via ETHERNET component 323 and WI-FI component 322 with premises device 300.

The BLUETOOTH component 324 of premises device 300 allows the premises device and premises software to perform presence detection of key personnel and communicate key personnel on site information to the cloud application on the cloud server. This may be achieved by the premises device sensing and identifying BLUETOOTH transmissions of cellular telephones, fobs, or other transmitters of key personnel registered with the AOP system as well as detecting BLUETOOTH signals signifying the presence of other persons that are not registered with the AOP system. The premises application on the premises device 300 (122 of FIG. 1) may report presence information to the cloud application on the cloud server (110 of FIG. 1).

All of the components in the premises device 300 may communicate over a single bus 314 or over multiple internal buses or other communication lines. The premises device 300 may provide alerts and/or information via an audio speaker 340 and lights such as LEDs (not shown) on a box or external unit. The premises device 300 has physical connectors that allow for connection to landline telephone, ETHERNET cable, and a myriad of sensors, components, security devices and control panels.

The example premises device 300 shown in FIG. 3 includes components that may be augmented by or replaced additional and different communications components and other technologies. For example, hardware and software supporting LoRa (Long Range) low-power wide-area network communications, Z-Wave wireless communications, Zigbee, and others may be included.

In some implementations the premises device 300 may include a rules engine that allows it to act independently as well as in conjunction with the cloud application on the cloud server. In this way, when highly urgent or important event triggers occur, the premises device can act on its own without communicating with the cloud server. This autonomous operation is important when lines of communication with the cloud server are down due to an unexpected or emergency situation such as an act of Nature or a power outage, or the cloud server being down. This autonomous operation of the premises device allows for actions to be taken by the premises device upon the occurrence of triggers and conditions when the cloud server is unavailable, inaccessible or upon emergency conditions.

### Processes

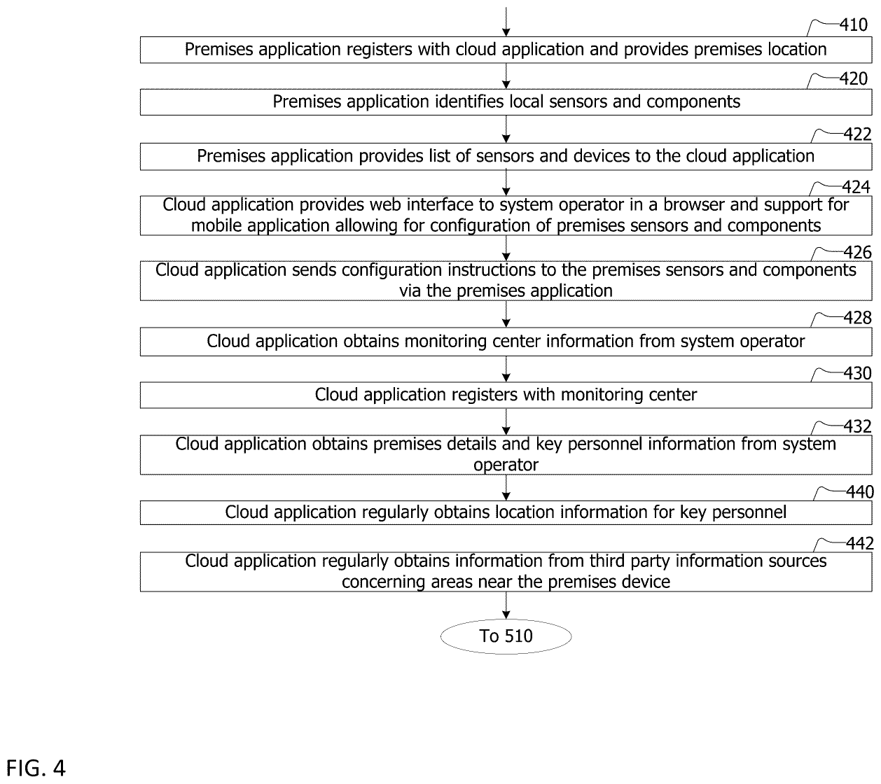

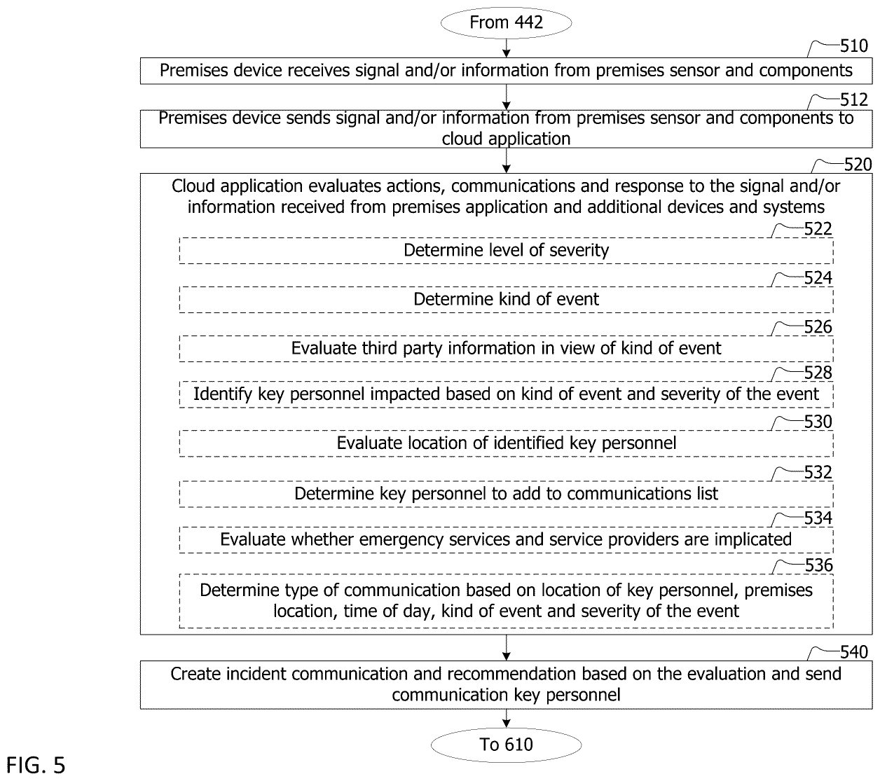

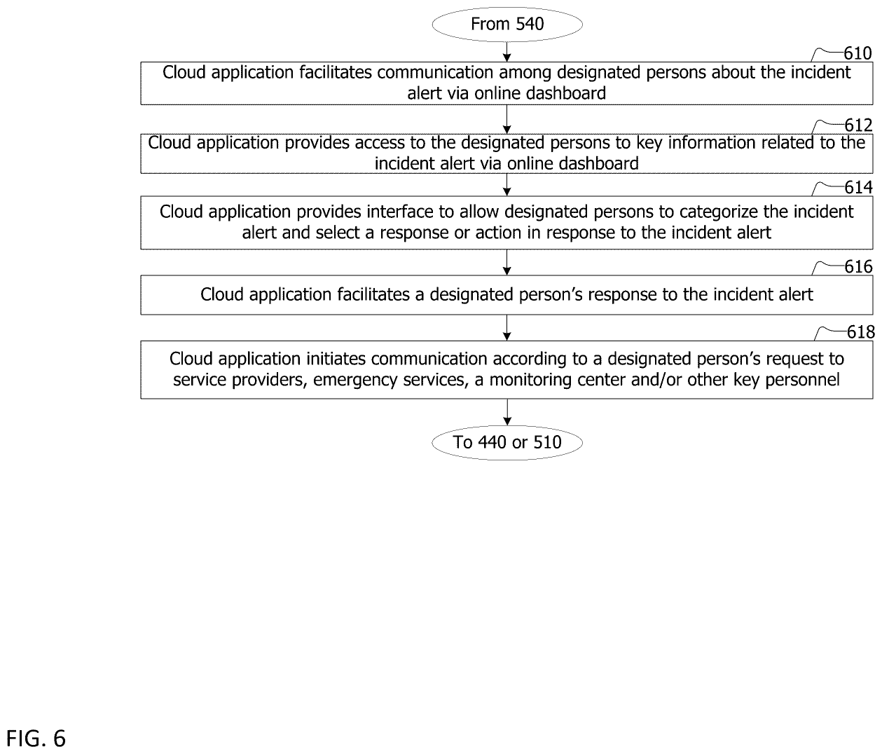

FIGS. 4, 5 and 6 are flow charts of actions taken according to the systems and methods described herein. FIG. 5 is a continuation from FIG. 4, and FIG. 6 is a continuation from FIG. 5. Blocks 410 through 432 of FIG. 4 describe actions taken as part of the initial configuration of the premises device with the cloud application and the premises sensors and components with the premises application. Starting with FIG. 4, the premises application registers with the cloud application and provides premises location for the premises device, as shown in block 410. The premises application may obtain its location from GPS signals, using the Internet address of the premises device or provided IP address by an internet service provider to the premises device. The premises application may obtain its location from a system operator specifying the location via a provided screen interface. Depending on the kind of premises, the premises application may regularly check in with the cloud application, such as when the premises device is on a boat, recreational vehicle or other movable structure or vehicle. The premises includes property and buildings, structures and/or vehicles adjacent to where the premises device is located. The premises application identifies local sensors and components that are in communication with the premises device, as shown in block 420. As described above, this could be by wireless or wired communications. The premises application provides list of sensors and devices to the cloud application, as shown in block 422. The cloud application provides a web interface to a system operator in a browser and support for an optional mobile application allowing for configuration of premises sensors and components by the system operator, as shown in block 424. The cloud application sends configuration instructions received from the system operator to the premises sensors and components via the premises application, as shown in block 426. As part of the initial configuration of the premises device with the cloud application, the cloud application obtains monitoring center information from the system operator, as shown in block 428, and the cloud application registers with the monitoring center, as shown in block 430.

The cloud application obtains premises details and key personnel information from the system operator, as shown in block 432. The actions here include obtaining names, titles, roles, positions and contact information for owners, managers, leaders, employees, in-house maintenance staff, in-house cleaning staff, and the like of the business at the premises and/or of the premises itself. In addition, the cloud application provides an interface allowing the system operator to specify third party service providers and may also allow for specifying key personnel from the third party service providers such as electricians, plumbers, HVAC contractors, cleaning company, landscaping company, chemical providers, and the like. This specification includes the names, titles, roles, positions and contact information for key people at the third party service providers. For all key personnel, designation of times available via specified communication media may be provided, such as home phone, work phone, mobile phone, email, WHATSAPP, SIGNAL, etc. In one optional embodiment, the cloud application regularly obtains location information for key personnel, as shown in block 440, so that decisions can be made about which key person from key personnel may be closest to the premises at a particular time. This allows for real-time decisions about who is best to contact regarding an incident. In another embodiment, the cloud application requests location information for key personnel when they connect to the cloud application platform in response to an incident notification.

In one optional embodiment, the cloud application regularly obtains information from third party information sources concerning areas near the premises device, as shown in block 442. The cloud application may communicate with multiple third party resources to obtain information pertinent to the decisions to be made and actions to be taken in response to local signals and information. The third party information sources include weather forecast providers, weather incidents providers, fire information, flood information, police activity, emergency service information, utilities such as water, electricity and gas as well as INTERNET connectivity.

Referring now to FIG. 5, the premises device receives a signal and/or information from premises a sensor and components, as shown in block 510. Examples of the kinds of signals and information include fire alert, temperature alert, smoke alert, door open alert, broken glass alert, humidity alert, water flow alert, roof access alert, panic button, biometric device access, fingerprint device access, retinal scan device access, Internet access down alert, window open alert, gunshot detected, electricity off alert, electricity use high alert, and others. The premises application sends the signal and/or information received from the premises sensor and components to the cloud application, as shown in block 512. In addition, the cloud application may receive signals, information, and the like amounting to incident information from additional devices and systems at the premises over a network (see in FIG. 1, additional device 126 and additional system 128 communicating over network 140 to the cloud application running on cloud server 110). The signals and information also include alerts and communications from PERS devices and systems which are additional devices and systems.

The cloud application then evaluates actions, communications and response to the signal and/or information received from the premises application as well as additional devices and systems, as shown in block 520. Multiple steps and actions are taken in this evaluation, some of which may be concurrent, others of which are sequential, and some or all may be iterative. Further, the steps and actions shown in block 520 are optional, such that not all are performed in every embodiment of the AOP system. The level of severity may be determined, as shown in block 522. This may be done by evaluating the difference in a current signal or information compared to normal signal or information. If a door open, then the determination is binary and simple. If a high temperature signal is received a further evaluation is made to determine how high the temperature is, and then machine learning and additional ongoing analysis and review of ongoing signals from the temperature sensor may be made. In some circumstances information from multiple sensors is evaluated concurrently to assist with a more accurate determination. For example, if a smoke alarm with a very high temperature showing a great difference from a normal temperature, then a determination may be made there is a fire, such that the event is a severe event. Similarly, if there is a high temperature that is 15 degrees greater than normal, and there is no smoke alert, then it may be an HVAC issue, and the cloud application may decide to recommend contacting an HVAC professional. This falls into the cloud application determining the kind of event, as shown in block 524. The cloud application may include both machine learning and an initial set of rules to assist in the evaluation of the severity and kind of event.

The cloud application also evaluates third party information in view of the kind of event, as shown in block 526. Continuing the same example, if a high temperature alert is received, a check of local weather conditions and local fire information may be made in evaluating who should be contacted in response to the high temperature alert. A more simple system may evaluate the temperature only and conclude a higher temperate is not a very important event. But checking the weather and fire conditions local to the premises may cause the system to elevate the severity of the event and more quickly notify key personnel and characterize the event as possible important to life and property rather than an inconvenience. The cloud application identifies key personnel impacted based on the kind of event and severity of the event, as shown in block 528. This group of key personnel is only a working set that is refined based on additional information. In this vein, the cloud application evaluates the location of identified key personnel, as shown in block 530. The location information may be based on static information entered by a system operator as to typical location during work hours and off-work hours. The location information may be based on real-time location information described above regarding block 440.

Returning to FIG. 5, the cloud application determines those key personnel to add to communications list based on specialty of the personnel, location of the personnel, severity of the event, and kind of the event, as shown in block 532. This may include narrowing or expanding the list created in block 528 (described above), depending on the pertinent information and factors. In conjunction with or after determining which key personnel to contact (block 532), an evaluation of whether emergency services and service providers are implicated, as shown in block 534. This includes consideration of the kind of event and severity of the event. For example, if a gas leak is detected, a recommendation to contact the local fire department and gas company may be included with an incident report. For example, if a personal emergency alert or communication via a PERS device or system is received, the cloud application may evaluate and determine that health care professionals and social worker should be notified by adding them to the communications list or that they should be included in recommendations provided to other key personnel, namely family members.

The cloud application determines the type of communication to use based on location of key personnel, premises location, time of day, kind of event and severity of the event, as shown in block 536. Location information may be obtained by the cloud application from presence information captured by the premises device via BLUETOOTH sensing and communications. Other information and factors may be included in determining the type of communication. The type of communication includes email, text message, direct message, automated voice phone call, other text message, and others. The cloud application then creates an incident communication and recommendation based on the evaluation and sends the communication to key personnel, as shown in block 540. The flow of actions then continues at block 610. The incident communication typically includes a link for access to the SaaS interface of the cloud application where the designated persons may view incident information and recommendations in real time, live as incident information is received by the cloud application from the premises device and additional devices and systems at the premises.

In one implementation in addition to creating an incident communication to be sent to key personnel, the cloud application may directly contact emergency services or utilities in certain situations where life or property is at risk, such as when a fire or gas leak is detected. Similarly, the cloud application may instruct the premises device to activate the sprinklers or run the air conditioning in certain circumstances when the sensors provide data and information indicative of these curative or ameliorating actions.

Referring now to FIG. 6, the cloud application facilitates communication among designated persons about the incident alert via online dashboard, as shown in block 610. The cloud application facilitates communication among designated persons by supporting video conferences, video calls, VOIP calls, text messaging, text chatting, and similar communications made available by the cloud application. This allows the designated persons to have an online meeting, online video conference, online phone call, online chat sessions about the incident while the cloud application provide real time information about the incident to the designated persons involved in the meeting, chart, conference, etc. via the SaaS portal and mobile application. The cloud application provides access to the designated persons to key information related to the incident alert via an online dashboard, as shown in block 612. This key information includes details about the incident as well as, in one embodiment, a recommendation provided by the cloud application about possible responses and actions to take. The cloud application supports designated persons logging into an SaaS dashboard, console or portal and optionally using a mobile application provided by the AOP system. The cloud application and optional mobile application allow multiple designated persons to view incident information in real time aka live. This real time, live information includes data and information from sensors, components, devices and systems at the premises made available via the premises device and additional devices and systems at the premises. This information includes temperature, humidity, door open alerts, window broken alerts, chemical alerts, live video, live audio, and others. The cloud application enables the designated persons to discuss via online text chat, audio communications or video conference the incident alert and current information provided by premises sensors, devices and components via the premises device and via additional devices and systems in communication with the cloud application. The cloud application enables the designated persons to invite other key personnel to join any communications regarding an incident using contact information stored in the cloud application. The cloud application provides designated persons the ability to view sensor data as well as view video feeds and audio feeds from a premises to empower the designated persons the ability to decide the action to take in response to the incident alert. The cloud application provides an interface to allow the designated persons the ability to categorize the incident alert and select a response or action in response to the incident alert, as shown in block 614. The categorization includes the ability to designate a kind of incident (flood, fire, safety, chemical spill, medical emergency) and a related severity on a scale provided by the cloud application, such as on a 1 to 10 or 1 to 5 numerical scale with the larger number being more severe. Lettered scales of severity may also be used. The categorization may be pre-designated by the cloud application's evaluation of the incident information. The cloud application may provide the designated person the ability to select a categorization from a list of categories, provide the ability to type in a category, or approved a cloud application pre-designated category, depending on the implementation.

The cloud application facilitates a designated person's response to the incident alert, as shown in block 616. The response may be a recommended, pre-designated action provided by the cloud application based on evaluation of the incident information, such as call fire department, call plumber, contact HVAC contractor, etc. In this embodiment, the designated persons may select from a recommended response communication or elect to select other actions available via the cloud application. The cloud application may include button or other graphical user interface elements for the recommended response. The recommended response may include the phone number, email address or web page for sending a request to other key personnel (See FIG. 1, 160 and FIG. 2, 260), a monitoring center (See FIG. 1, 150 and FIG. 2, 250), emergency services (See FIG. 1, 180 and FIG. 2, 280) and/or service providers (See FIG. 1, 170 and FIG. 2, 270). The cloud application then initiates communication according to a designated person's response request to service providers, emergency services, a monitoring center and/or other key personnel, as shown in block 618. The flow of actions then continues at block 440 of FIG. 4 or block 510 of FIG. 5.

The cloud application may record the entire incident including camera views, phone call, video call, incident data, sensor data, screen recording, etc. In one embodiment, the recording may be made by default. In another embodiment, any of the participating key persons may initiate a recording of the incident information, discussion, response, etc. by using a “record” button provided by the cloud application in the user interface to the web portal or on the mobile application. This ability to record allows for the entirety of all aspects of the incident to be recorded and saved for future reporting and analysis.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system comprising:
a server computer including a processor, a server storage device, memory, a communications device all coupled with a bus, the communications device coupled with the Internet, the server storage device having instructions stored thereon which when executed cause the server to execute a cloud application;
a premises device at a first location, the premises device having a processor, a memory, and a plurality of communications devices all coupled with a bus, the communications devices supporting a wired Internet connection and/or a wireless Internet connection, the premises device in local communication with a plurality of premises sensors
the premises device further including a storage device coupled with the bus, the storage device having instructions stored thereon which when executed cause the premises device to execute a premises application and perform actions including:
regularly receiving signals and information from the premises sensors,
reporting signals and information from premises sensors to the cloud application;
the cloud application regularly polling and/or receiving signals from the premises device over a network;
the cloud application regularly polling and/or receiving signals from additional components and systems over a network;
the cloud application receiving key person information for a plurality of key persons;
upon receipt of signals and information from the premises application and/or the additional components and systems, the cloud application performs actions including:
preparing an incident alert including signals and information received from the premises device and/or the additional components and systems,
creating a recommendation to be sent with the incident alert including evaluating a recommended action to take, the evaluating including considering at least two of a current time of day, a kind of event, a level of severity, a source of the signal and information, a day of the week,
sending the incident alert to a plurality of key persons along with the recommendation via at least one of email, text message, phone call,
facilitating communication among the plurality of key persons including providing video, audio and text communication along with real time information about the incident alert.

2. The system of claim 1 wherein the premises sensors include at least three selected from the group including a temperature sensor, a motion sensor, a biometric sensor, a humidity sensor, a fire sensor, a door sensor, a window sensor, an alarm panel, a man-trap, a card reader, a retina reader, a smoke sensor, a fingerprint reader, a tamper detector, a door sensor, a window sensor, a roof sensors, a humidity sensor, a water system sensor, an electrical system sensor, a gunshot detector, a glass break sensor.

3. The system of claim 1 wherein the key person information includes at least three of the following: home phone number, cellular telephone number, email address, home address, a role designation, a specialty designation, hours at home, hours at work.

4. The system of claim 1 wherein the key persons include employees and leaders of a company at the first location or family members associated with the first location.

5. The system of claim 1 wherein the local communication is wired or wireless or a combination of wired and wireless.

6. The system of claim 1 wherein the evaluating includes obtaining and considering information from third party information sources.

7. The system of claim 6 wherein the third party information sources include at least three selected from the group including: a weather forecast provider, a current weather condition provider, a police activity provider, a fire activity provider, a government emergency alert provider, a water company, an electric company, and an Internet status provider.

8. The system of claim 1 wherein the cloud application receiving key person information for a plurality of key persons includes receiving geographical location information for at least one of the plurality of key persons.

9. The system of claim 1 wherein the cloud application receiving key person information for a plurality of key persons includes receiving pairings of location and contact information for at least one of the plurality of key persons.

10. The system of claim 1 wherein the sending the incident alert includes determining whether to send an incident alert to a key person based on matching a specialty of the key person with a kind of the source of the signal, a current location or home address of the key person in relation to the first location, and third party information, the actions selected from a list including texting at least one key person, sending an email note to at least one key person, sending instructions via at least one communication channel to the monitoring center to take further action.

11. The system of claim 1 wherein the wireless Internet connection includes a cellular telephone connection, a satellite communications connection, and/or a WI-FI connection.

12. The system of claim 1 wherein the premises sensors include at least three selected from the group including: a door sensor, a window sensor, a roof sensor, at least one humidity sensor, a water system sensor, an electrical system sensor, at least one temperature sensor, a plurality of fire sensors, at least one access reader device, at least one gunshot detector, at least one motion detector, at least one network device, and at least one glass break sensor, an alarm panel, a keypad, a man-trap, a card reader, a retina reader, a smoke sensor, a fingerprint reader, an analog phone, a SIP phone, a virtual wire, a tamper detector.

13. The system of claim 1 wherein the cloud application receiving key person information for a plurality of key persons includes regularly receiving current location information of at least one of the plurality of key persons.
